(19) United States
(12) Patent Application Publication
(10) Pub. No.: US 2023/0306336 A1
(43) Pub. Date: Sep. 28, 2023

(54) PROCESS MODEL CREATION SYSTEM AND METHOD

(71) Applicant: Hitachi, Ltd., Tokyo (JP)

(72) Inventors: Takehiro HAGIWARA, Tokyo (JP); Hitoshi ISHIDA, Tokyo (JP); Riku KAWAMURA, Tokyo (JP); Hiroki MIYAMOTO, Tokyo (JP)

(21) Appl. No.: 17/952,541

(22) Filed: Sep. 26, 2022

(30) Foreign Application Priority Data
Mar. 23, 2022 (JP) 2022-047496

(51) Int. Cl. G06Q 10/06

(52) U.S. Cl. CPC G06Q 10/06316; G06Q 10/067; G06Q 10/0633

(57) ABSTRACT

To provide a technique for supporting generation of a process model suitable for a task generated on a site. A process model creation system creates a model used for managing, in a process including a plurality of tasks, site data acquired on a site of each task, and defining a flow of the tasks in the process. The process model creation system includes: a model accumulation unit configured to accumulate the model; a difference data creation unit configured to create, based on the site data acquired on the site, an instance indicating a flow of actually executed tasks, and extract differences between the instance and the model as difference data; and a model modification unit configured to create a modification proposal of the model based on the difference data.

### CROSS-REFERENCE TO RELATED APPLICATION

The present application claims priority from Japanese application JP2022-047496, filed on Mar. 23, 2022, the contents of which is hereby incorporated by reference into this application.

### TECHNICAL FIELD

The present invention relates to a technique for creating a process model.

### BACKGROUND ART

At a site of each task in a company, data generated on the site (hereinafter, also referred to as “site data”) is collected in response to completion of the task or occurrence of a predetermined event. Site workers analyze the site data to improve work efficiency of the task.

For example, a manufacturing process of a manufacturing industry may include various tasks, and departments managing the tasks may be different departments. In a case where the departments managing the tasks are different departments, it may be difficult to share information among the departments. The reason is considered to be that systems for managing the tasks are different depending on departments, and the like. Therefore, a current situation is that each department analyzes the site data collected within the department, so as to improve the work efficiency of the task within the department. However, in order to improve work efficiency of the manufacturing process as a whole, cooperation among the departments is essential. It is considered to promote the cooperation among the departments by associating the site data generated not only within the department, but also throughout the manufacturing process.

This problem is not specific to a manufacturing site in the manufacturing industry, and is also present in companies of various other industries. Similar problems are present in an industry that includes a series of processes including a plurality of tasks, such as a logistics industry, a retail industry, or a service industry.

PTL 1 discloses an information collection system “including an association data accumulation unit that stores association data defining association of each of a plurality of pieces of information included in site data; an association data search unit that searches for second information associated with first information included in the plurality of pieces of information, based on the association data stored in the association data accumulation unit; and a user interface unit that displays a connection relation of the plurality of pieces of information associated by the association data, in which the association data search unit searches for the second information associated with the first information based on the association data, in response to selection of the first information in the connection relation of the plurality of pieces of information displayed on the user interface unit, and displays the first information and the second information on the user interface unit together with the connection relation of the plurality of pieces of information”. The information collection system of PTL 1 manages information of a manufacturing process by using an association data model indicating a structure of the association data defining the association of each of the plurality of pieces of information included in the site data generated in the tasks included in the manufacturing process and using the association data.

PTL 2 discloses a technique for extracting a difference between a defined task process model and a current task process model and proposing an improvement proposal.

PTL 3 proposes detecting a difference between a model for defining a proceeding method of a task and information related to an executed task, and quantifying the difference.

### CITATION LIST

### Patent Literature

PTL 1: JP-A-2019-153051
PTL 2: JP-A-2020-126301
PTL 3: JP-A-2011-81620

### SUMMARY OF INVENTION

### Technical Problem

For example, when a data structure of site data of a manufacturing process is defined in a process model and the site data is managed by using the process model, the site data actually generated on the site may have a data structure different from the data structure defined in the process model. Such site data cannot be managed by the process model defined in advance. The reason why the actually generated site data has a data structure different from the data structure defined in advance in the process model is considered to be that unusual tasks generate due to repair work, and that a change in a task flow on the site is not reflected in the process model. However, PTL 1 to PTL 3 do not disclose how to create a process model suitable for a task actually generated on the site.

One object of the present disclosure is to provide a technique for supporting generation of a process model suitable for a task generated on a site.

### Solution to Problem

A process model creation system according to one aspect included in the present disclosure is a process model creation system for creating a model used for managing, in a process including a plurality of tasks, site data acquired on a site of each task, and defining a flow of the tasks in the process. The process model creation system includes: a model accumulation unit configured to accumulate the model; a difference data creation unit configured to create, based on the site data acquired on the site, an instance indicating a flow of actually executed tasks, and extract differences between the instance and the model as difference data; and a model modification unit configured to create a modification proposal of the model based on the difference data.

### Advantageous Effects of Invention

According to the aspect included in the present disclosure, the differences between the flow of the tasks indicated by the instance created based on the data actually acquired on the site and the flow of tasks indicated by the model created in advance are extracted, and a modification proposal of the model is created based on the differences, and thus a process model suitable for the tasks generated on the site can be created.

### BRIEF DESCRIPTION OF DRAWINGS

FIG. 1 is a block diagram illustrating a configuration example of a data management system to which a process model creation system is applied.

FIG. 2 is a block diagram illustrating a functional configuration of the process model creation system.

FIG. 3 is a diagram illustrating an example of a procedure of processing of creating and registering a schema model.

FIG. 4 is a diagram illustrating an example of a procedure of processing of creating a result instance and creating difference data based on the result instance and the schema model.

FIG. 5 is a diagram illustrating an example of a procedure of processing of creating a modification proposal of the schema model based on the difference data and modifying the schema model.

FIG. 6 is a diagram illustrating an example of information included in master data registered in a master data accumulation unit.

FIG. 7 is a diagram illustrating an example of information included in plan data registered in a plan data accumulation unit.

FIG. 8 is a diagram illustrating an example of information included in site data registered in a site data accumulation unit.

FIG. 9 is a diagram illustrating an example of a relation between a manufacturing process and tasks in the present embodiment.

FIG. 10 is a diagram illustrating an example of a model of a manufacturing process including a plurality of tasks and a model of each task in the manufacturing process.

FIG. 11 is a diagram illustrating an example of a data structure of a result instance of one material for which tasks are executed.

FIG. 12 is a diagram illustrating an example of a procedure for the process model creation system to create the schema model.

FIG. 13 is a diagram illustrating an example of a procedure for the process model creation system to create the result instance and the difference data.

FIG. 14 is a diagram illustrating an example of a procedure for creating a task flow in step S906 of FIG. 13.

FIG. 15 is a diagram illustrating an example of a procedure for creating the result instance by associating, with the task flow, information related to the tasks and information on components used to generate a product, in step S907 of FIG. 13.

FIG. 16 is a diagram illustrating an example of a procedure for creating the difference data based on the result instance and the schema model in step S908 of FIG. 13.

FIG. 17 is a diagram illustrating a specific example of extracting difference information between a product type schema model and result instances.

FIG. 18 is a diagram illustrating a specific example of the difference data obtained by accumulating difference information.

FIG. 19 is a diagram illustrating a specific example of a degree of similarity of the difference information stored in the difference data.

FIG. 20 is a diagram illustrating an example of a schema model and result instances when a type Y product is created using a type X product as a component.

FIG. 21 is a diagram illustrating an example of a procedure for the process model creation system to create the modification proposal of the schema model based on the schema model and the difference data.

FIG. 22 is a diagram illustrating an example in which a schema model modification unit adds to a task node added in the modification proposal a characteristic indicating that the added task node is a task node associated with a repair task.

FIG. 23 is a diagram illustrating an example in which the schema model modification unit adds to a task node added in the modification proposal a characteristic indicating that the added task node is a task node associated with a sampling inspection task.

FIG. 24 is a diagram illustrating an example of a screen that presents the modification proposal of the schema model to a user.

FIG. 25 is a diagram illustrating an example of displaying differences in a data structure to be modified in the modification proposal of the schema model.

FIG. 26 is a diagram illustrating an example of an interface that displays detailed information related to similarity of mutually similar differences.

### DESCRIPTION OF EMBODIMENTS

Hereinafter, embodiments of the present disclosure will be described with reference to the drawings.

The embodiment described below does not limit the invention according to the claims, and all elements and combinations thereof described in the embodiment are not necessarily essential to the solution of the invention.

The present embodiment describes, as an example, a case in which a process model creation system is applied to an information collection system that collects site data generated in a process of each manufacturing step in a manufacturing factory and/or tasks in the process. However, a similar process model creation system can also be applied to an information collection system used in a process including a plurality of continuous tasks or steps in various industries such as a logistics industry, a retail industry, or a service industry.

### <Block Diagram>

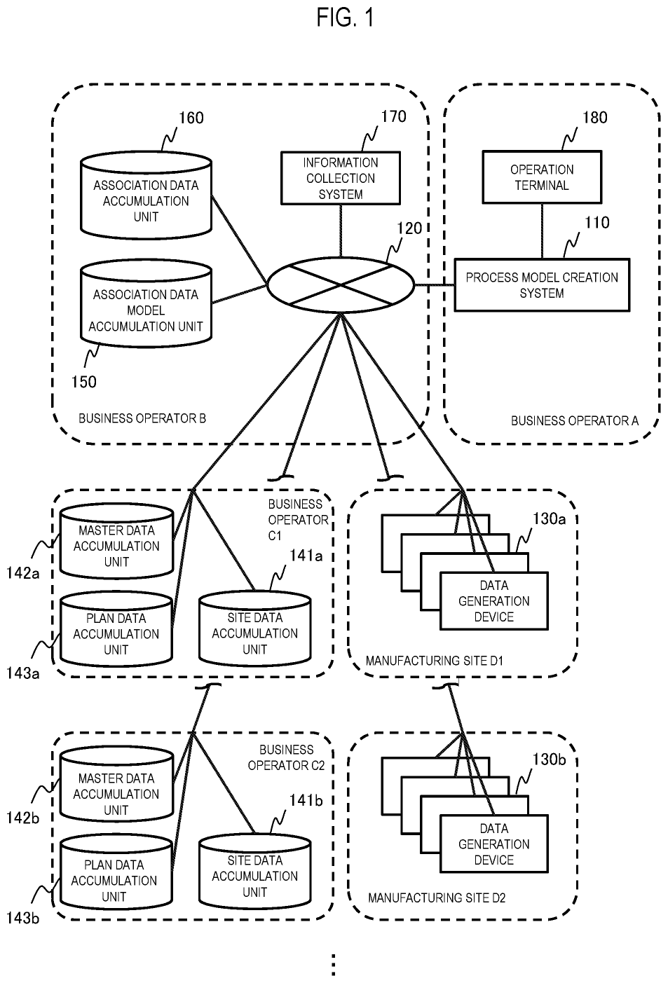

FIG. 1 is a block diagram illustrating a configuration example of a data management system to which a process model creation system is applied.

In FIG. 1, a process model creation system 110 is connected to a network 120. One or more data generation devices 130, one or more site data accumulation units 141, one or more master data accumulation units 142, one or more plan data accumulation units 143, an association data model accumulation unit 150, and an association data accumulation unit 160 are connected to the network 120. The process model creation system 110, the data generation devices 130, the site data accumulation units 141, the master data accumulation units 142, the plan data accumulation units 143, the association data model accumulation unit 150, and the association data accumulation unit 160 are connected to an information collection system 170 via the network 120.

An operation terminal 180 for operating the process model creation system 110 is connected to the process model creation system 110.

The data generation device 130 may be, for example, a bar code reader or a personal computer (PC) that acquires a work log of a worker, or a server, may be a machine that processes a component or assembles a finished product, or may be a sensor that collects inspection information on a radio frequency identifier (RFID) attached to the component or the finished product. Site data collected or generated by these data generation devices 130 is transmitted to the site data accumulation unit 141 via the network 120.

The site data accumulation unit 141 is, for example, a server or a storage device such as a memory, and the site data accumulation unit 141 stores the site data acquired by the data generation device 130.

The association data model accumulation unit 150 is, for example, a server or a storage device such as a memory, and stores a model that defines a flow of tasks in a process. The model is also referred to as an association data model. The association data model determines what kind of information is to be collected from the site data accumulation unit 141. By changing the association data model defined by the association data model accumulation unit 150, site data to be collected from the site data accumulation unit 141 can be changed.

The association data accumulation unit 160 is, for example, a server or a storage device such as a memory, and stores data indicating association of the site data stored in the site data accumulation unit 141. The data is also referred to as association data. The association data indicates what kind of task flow is generated on the site.

The information collection system 170 collects information related to execution of a task. The information related to the execution of a task is, for example, an execution record related to the execution of a task. The execution record related to the execution of a task may include task information related to the execution of a task and task-related information related to the task. The task-related information includes, for example, any one or more pieces of information on such as materials, humans, and equipment related to the execution of a task, and a procedure of work included in the task.

Based on a data structure defined by the association data model acquired from the association data model accumulation unit 150 and the association data acquired from the association data accumulation unit 160, the information collection system 170 collects, from the site data accumulation unit 141, the site data indicating the execution record related to the execution of a task included in the data structure and the site data indicating the execution record related to the execution of a task included in the association data.

A business operator owning the process model creation system 110 may be the same as a business operator owning the information collection system 170. A business operator owning the site data accumulation unit 141, the master data accumulation unit 142, and the plan data accumulation unit 143 may be the same as the business operator owning the information collection system 170 or the business operator owning the process model creation system 110. The site data accumulation unit 141, the master data accumulation unit 142, and the plan data accumulation unit 143 may be positioned at a manufacturing site where the data generation device 130 is present, may be positioned at a position where the business operator owning the information collection system 170 is present, or a position where the business operator owning the process model creation system 110 is present, or may be positioned at any of the above positions.

### <System Configuration>

Next, main functions of the process model creation system 110 will be described.

The process model creation system 110 is implemented on a computer including a central processing unit (CPU) that executes overall control of the process model creation system 110, a storage device (read-only memory: ROM) that stores various processing programs for implementing the functions of the process model creation system 110, a primary storage device (random access memory: RAM) that temporarily stores information, a non-transitory storage device such as a hard disk drive (HDD), and the like, and the following functions are implemented by the CPU executing the various processing programs stored in the ROM. These programs may be partially or entirely introduced from another device via a non-transitory storage medium or a communication line, or may be stored in advance.

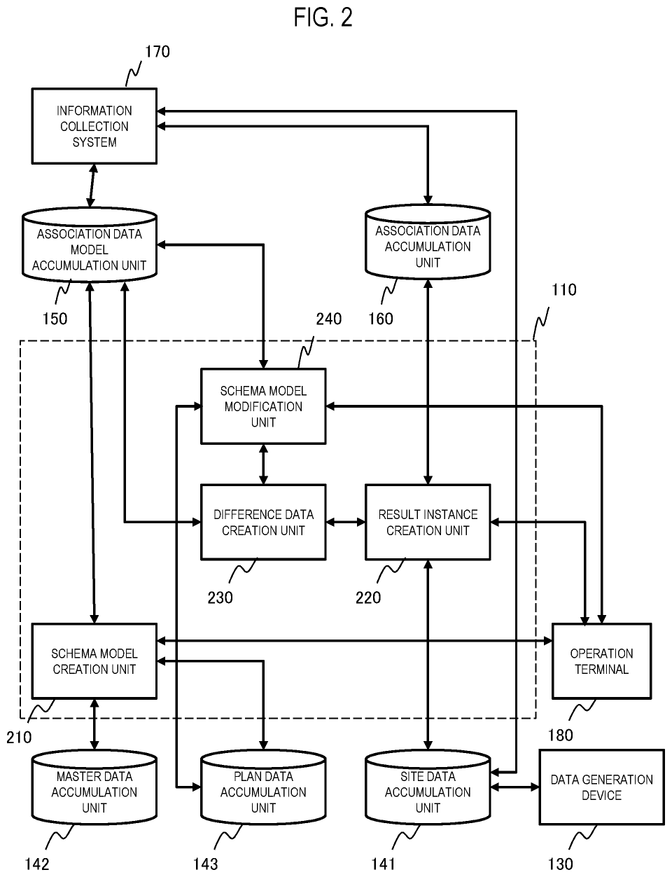

FIG. 2 is a block diagram illustrating a functional configuration of the process model creation system 110.

As illustrated in FIG. 2, the process model creation system 110 includes a schema model creation unit 210, a result instance creation unit 220, a difference data creation unit 230, and a schema model modification unit 240.

As described above, the process model creation system 110 is connected to the site data accumulation unit 141, the master data accumulation unit 142, the plan data accumulation unit 143, the association data model accumulation unit 150, and the association data accumulation unit 160 via the network 120.

As described above, the process model creation system 110 is connected to the operation terminal 180. The operation terminal 180 provides a user with an environment for inputting predetermined information to the schema model creation unit 210, the result instance creation unit 220, and the schema model modification unit 240.

The process model creation system 110 creates, based on master data acquired from the master data accumulation unit 142 and plan data acquired from the plan data accumulation unit 143, the association data model (hereinafter, also referred to as a schema model) indicating, by the data structure, association of the site data related to the tasks constituting the process. The process model creation system 110 creates, based on the site data acquired from the site data accumulation unit 141, the association data (hereinafter, also referred to as a result instance) indicating, by a data structure, the association of the site data related to the tasks constituting the process. The schema model is modified based on differences between the data structure of the created result instance and the data structure of the schema model.

The schema model creation unit 210 creates the schema model based on the master data registered in the master data accumulation unit 142 and the plan data registered in the plan data accumulation unit 143, and registers the schema model in the association data model accumulation unit 150.

The result instance creation unit 220 creates the result instance based on the site data registered in the site data accumulation unit 141, and registers the result instance in the association data accumulation unit 160.

The difference data creation unit 230 compares, for one or more result instances created by the result instance creation unit 220 and the schema model registered in the association data model accumulation unit 150, the data structure of each result instance with the data structure of the schema model, and creates difference data which is an accumulation of difference information.

The schema model modification unit 240 modifies the schema model based on the difference data created by the difference data creation unit 230, and registers the modified schema model in the association data model accumulation unit 150.

The information collection system 170 collects the site data from the site data accumulation unit 141 using the schema model that is created by the process model creation system 110 and that is registered in the association data model accumulation unit 150 and the result instance registered in the association data accumulation unit 160.

### <Operation Procedure>

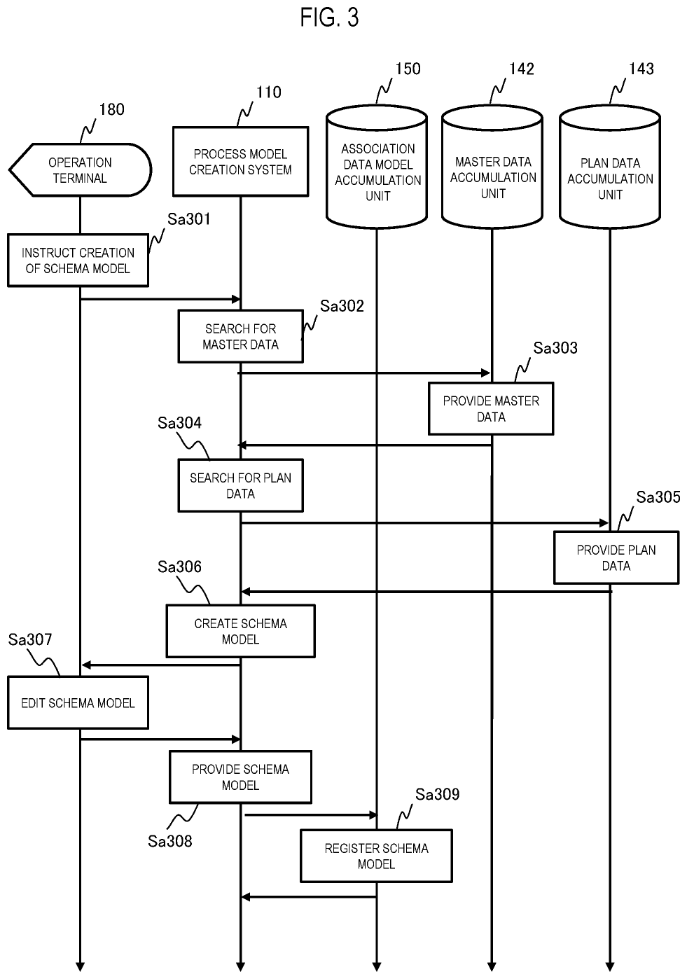

FIG. 3 is a diagram illustrating an example of a procedure of processing of creating and registering the schema model.

The user using the process model creation system 110 uses the operation terminal 180 to instruct the process model creation system 110 to create a schema model of a desired process (Sa301). The user may use the operation terminal 180 to designate a time interval for the process model creation system 110 to create the schema model. In that case, the process model creation system 110 executes the processing of creating the schema model at designated time intervals.

Next, the process model creation system 110 acquires master data and plan data from the master data accumulation unit 142 and the plan data accumulation unit 143, respectively (Sa302, Sa304).

Next, the master data accumulation unit 142 and the plan data accumulation unit 143 respectively provide the master data and the plan data to the process model creation system 110 (Sa303, Sa305).

Next, the process model creation system 110 specifies a task flow represented by the master data and the plan data, and creates the schema model indicating the specified task flow with a data structure (Sa306).

Next, the user edits the schema model from the operation terminal 180 (Sa307). The process model creation system 110 may provide a user interface for editing the schema model created in step Sa306, and the user may edit the schema model from the user interface.

Next, the process model creation system 110 provides the created and edited schema model to the association data model accumulation unit 150 (Sa308).

Next, the association data model accumulation unit 150 registers the schema model provided from the process model creation system 110 (Sa309).

Here, the process model creation system 110 may search for the plan data (Sa304) before searching for the master data (Sa302), or may search for the master data and the plan data simultaneously. The process model creation system 110 may receive the plan data before receiving the master data. An order of the processing from step Sa301 to step Sa309 in FIG. 3 may be changed as long as the schema model is created based on the master data and the plan data, and registered in the association data model accumulation unit 150.

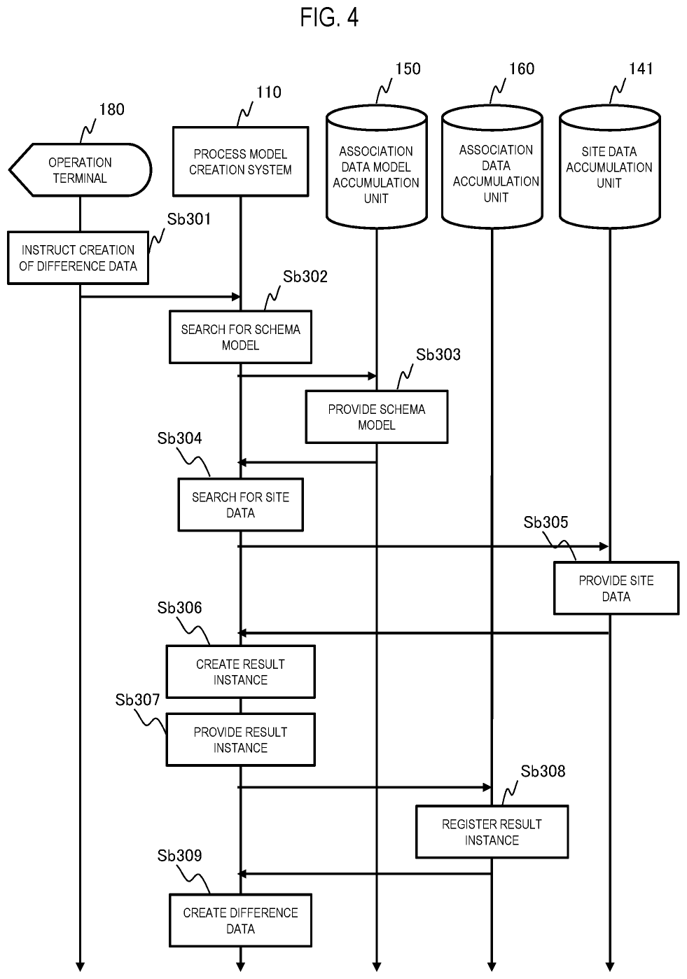

FIG. 4 is a diagram illustrating an example of a procedure of processing of creating the result instance and creating the difference data based on the result instance and the schema model.

The user uses the operation terminal 180 to instruct the process model creation system 110 to create the difference data (Sb301). Alternatively, the user may use the operation terminal 180 to designate a time interval for the process model creation system 110 to create the difference data. In that case, the process model creation system 110 executes the processing of creating the difference data at designated time intervals.

Next, the process model creation system 110 searches for the schema model related to the desired process from the association data model accumulation unit 150 (Sb302).

Next, the association data model accumulation unit 150 provides the schema model to the process model creation system 110 (Sb303).

Next, the process model creation system 110 searches for corresponding site data related to the desired process from the site data accumulation unit 141 (Sb304).

Next, the site data accumulation unit 141 provides the site data to the process model creation system 110 (Sb305).

Next, the process model creation system 110 specifies a work flow represented by the site data, and creates the result instance indicating the specified task flow with a data structure (Sb306).

Next, the process model creation system 110 provides the created result instance to the association data accumulation unit 160 (Sb307).

Next, the association data accumulation unit 160 registers the provided result instance (Sb308).

Next, the process model creation system 110 extracts differences between the created result instance and the schema model registered in the association data model accumulation unit 150, and creates the difference data based on the differences (Sb309).

Here, the process model creation system 110 may search for the site data (Sb304) before searching for the schema model (Sb302), or may search for the schema model and the site data simultaneously. The process model creation system 110 may receive the site data before receiving the schema model. An order of the processing from step Sb301 to step Sb309 in FIG. 4 may be changed as long as the difference data can be created based on the differences between the schema model and the result instance created based on the site data.

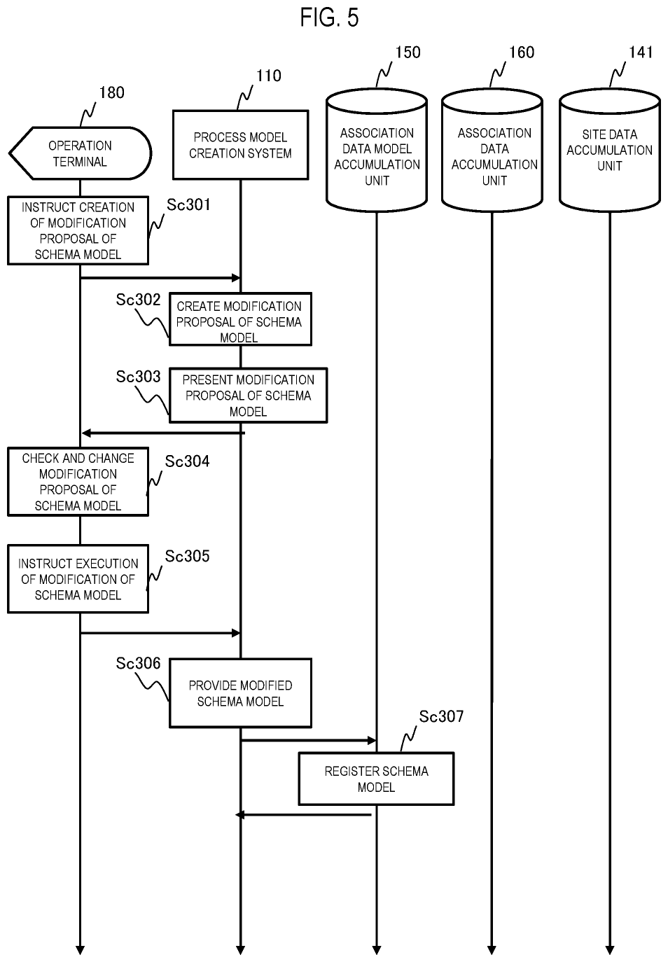

FIG. 5 is a diagram illustrating an example of a procedure of processing of creating a modification proposal of the schema model based on the difference data and modifying the schema model.

The user instructs, via the operation terminal 180, the process model creation system 110 to create the modification proposal of the schema model (Sc301). Alternatively, the user may use the operation terminal 180 to designate a time interval for the process model creation system 110 to create the modification proposal of the schema model. In that case, the process model creation system 110 executes the processing of creating the modification proposal of the schema model at designated time intervals.

Next, the process model creation system 110 creates the modification proposal of the schema model based on the difference data (Sc302), and sends the modification proposal to the operation terminal 180 (Sc303). At the operation terminal 180, the modification proposal of the schema model is presented to the user.

Next, the user uses the operation terminal 180 to instruct the modification of the schema model based on the modification proposal of the schema model presented at the operation terminal 180 (Sc305). At this time, the user may adopt the presented modification proposal of the schema model as it is, or may change the presented modification proposal of the schema model by operating the operation terminal 180 (Sc304).

Next, the process model creation system 110 provides the modification proposal of the schema model, which is created based on the instruction, to the association data model accumulation unit 150 as a new schema model (Sc306).

Next, the association data model accumulation unit 150 registers the provided schema model (Sc307).

### <Data Content>

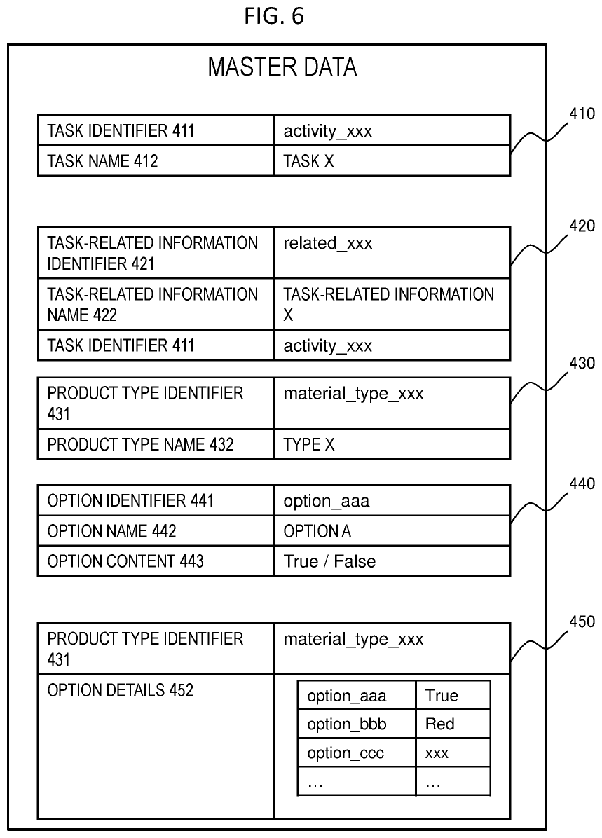

FIG. 6 is a diagram illustrating an example of information included in the master data registered in the master data accumulation unit 142.

The master data is design information defining each task executed in a factory in which a process of manufacturing a product is implemented by various tasks.

The master data includes task information 410, task-related information 420, product type information 430, option information 440, product type detailed information 450, and the like.

The task information 410 includes a task name 412 indicating a name of a task, and the like in association with a task identifier 411 for uniquely identifying the task.

The task-related information 420 includes a task-related information name 422 indicating a name of task-related information, the task identifier 411 for uniquely identifying a task associated with the task-related information and the like, in association with a task-related information identifier 421 for uniquely identifying the task-related information.

The product type information 430 includes a product type name 432 indicating a name of a product type indicating a type of a product and the like in association with a product type identifier 431 for uniquely identifying the product type.

Here, the product type indicating the type of the product may be determined based on, for example, options of the product. The option information 440 includes an option name 442 indicating a name of an option, an option content 443 indicating a content of the option, and the like in association with an option identifier 441 for uniquely identifying the option. The option content 443 may include, for example, information such as choices that can be taken by the product in the option.

The product type detailed information 450 includes option details 452 indicating details of the options in the product type, and the like in association with the product type identifier 431 for uniquely identifying the product type indicating the type of the product. The option details 452 may include, for example, information such as what kind of choices each option have in the product type.

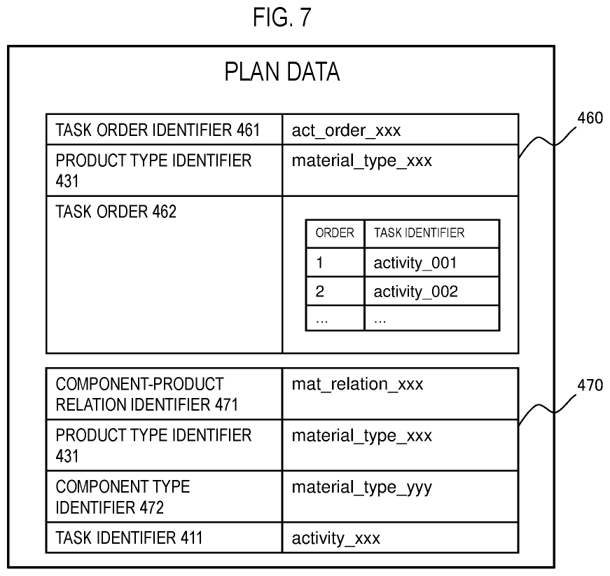

FIG. 7 is a diagram illustrating an example of information included in the plan data registered in the plan data accumulation unit 143.

The plan data is information defining details of each of a series of tasks included in the process of manufacturing the product.

The plan data includes task order information 460, component-product relation information 470, and the like.

The task order information 460 includes the product type identifier 431 for uniquely identifying a target product type, a task order 462 that is information on a task order, and the like in association with a task order identifier 461 for uniquely identifying the task order. The information on the task order includes an order number, a task identifier for uniquely identifying a task to be executed in that order, and the like.

The component-product relation information 470 includes the product type identifier 431 for uniquely identifying a type of a product to be created, a component type identifier 472 that is the product type identifier 431 for uniquely identifying a type of a component to be used to create the product, the task identifier 411 for uniquely identifying a task in which the component is used, and the like in association with a component-product relation identifier 471 for uniquely identifying a component-product relation.

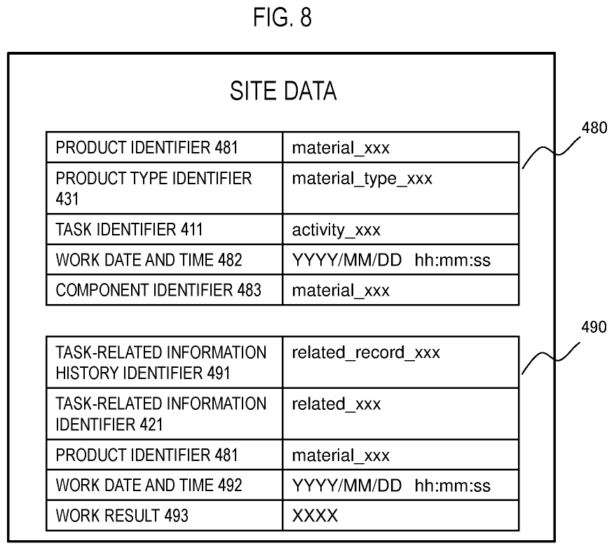

FIG. 8 is a diagram illustrating an example of information included in the site data registered in the site data accumulation unit 141.

The site data is information acquired from tasks actually executed on the site in the process of manufacturing a product.

The site data includes task history information 480, task-related information history information 490, and the like.

The task history information 480 includes information indicating a timing at which the task is executed, a component identifier 483 for uniquely identifying the component used for creating the product, and the like in association with a product identifier 481 for uniquely identifying the product, the product type identifier 431 for uniquely identifying the product type, and the task identifier 411 for uniquely identifying the task.

The information indicating the timing at which the task is executed may indicate the timing by date and time. In the example of FIG. 8, work date and time 482 is the information indicating the timing at which the task is executed. The information indicating the timing at which the task is executed may indicate the timing by start date and time and end date and time of the task.

The product identifier 481 may be the same as the component identifier 483 when a component before the task is the same as a product after the task.

When a product is created using a plurality of components, the task history information 480 may include a plurality of component identifiers 483.

The task-related information history information 490 includes the task-related information identifier 421 for uniquely identifying the task-related information, the product identifier 481 for uniquely identifying the product, information indicating a timing at which the task-related information is generated, history information of the information related to the task, and the like in association with a task-related information history identifier 491 for uniquely identifying a task-related information history.

The information indicating the timing at which the task-related information is generated may indicate the timing by date and time. In the example of FIG. 8, work date and time 492 is information indicating the timing at which the task-related information is generated. The information indicating the timing at which the task-related information is generated may be start date and time and end date and time of the task related to the generated task-related information. The history information of the information related to the task may be, for example, information on a worker who executed the task, information on equipment used to execute the task, information on a work procedure for executing the task, and the like. In the example of FIG. 8, a work result 493 is used as the history information of the information related to the task.

In the following description, time information is used as the information which is included in the site data and which indicates the timing at which the task is executed.

### <Process Configuration>

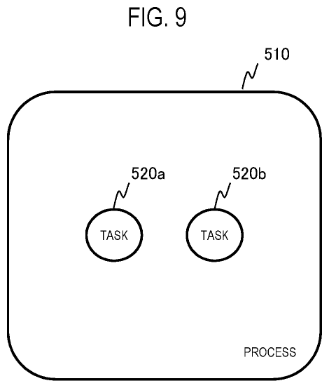

FIG. 9 is a diagram illustrating an example of a relation between the manufacturing process and tasks in the present embodiment. The manufacturing process includes one or more tasks for generating a product. In the embodiment, each of units of the site data distinguished by the task identifier 411, which is included in the task information 410 and used for uniquely identifying the task, is defined as one task. In the example of FIG. 9, a process 510 includes a task 520a and a task 520b.

### <Schema Model Configuration>

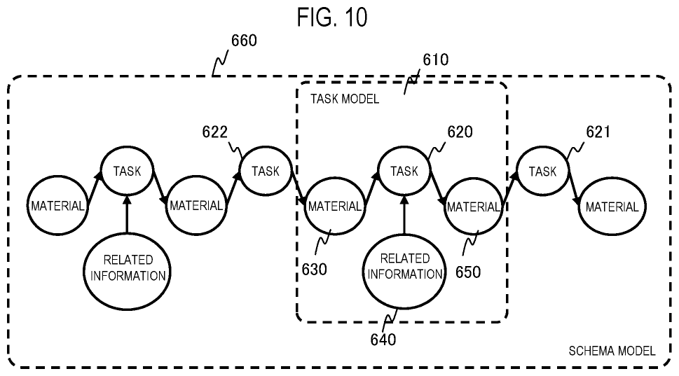

FIG. 10 is a diagram illustrating an example of a model of a manufacturing process including a plurality of tasks and a model of each task in the manufacturing process. FIG. 10 illustrates a task model representing the task and a schema model representing the manufacturing process.

In FIG. 10, the task model indicates, by associating site data generated from various devices (the data generation devices 130) in each task, what kind of workers, machines, components, and the like are associated by what kind of work procedure and in what manner for a predetermined task. A task model 610 includes, for example, a task node 620 associated with a task at the center, a component node 630 associated with a component necessary for executing the task, a task-related information node 640 associated with a worker executing the task, a machine used to execute the task, or a work procedure that defines a procedure for executing the task, a product node 650 associated with a product generated based on the component in the task, and the like.

The product node 650 associated with the product of the task associated with the task node 620 is a component node associated with a component to be used in a next task associated with a task node 621. The component node 630 associated with a component of the task associated with the task node 620 is a product generated in a previous task associated with a task node 622. In other words, both the component and the product are materials, and the material associated with the component node 630 and the material associated with the product node 650 are the same in terms of attributes of the component and the product. When the component and the product are not particularly distinguished from each other, the component and the product may be collectively referred to as material nodes.

As described above, the component (Material) node 630, the product (Material) node 650, and the task-related information node 640 associated with a worker (Man), equipment (Machine), a work procedure (Method), and the like may be referred to as 4 M information or 4 M nodes. However, the task-related information is not limited to the 4 M information. For example, the task-related information may be 5 M information including information on measurement executed in the task in addition to the 4 M information. The task-related information may be 1 M to 3 M information that does not include any one or more of the 4 M information. The task-related information may include information on the quality of the product on which the task is executed. The task-related information may include information on an environment in which the task is executed and information on a management state (management).

In FIG. 10, the schema model indicates association of the task model for each task constituting the manufacturing process. In the schema model, the task model for each task constituting the manufacturing process is associated via the material nodes. In a schema model 660, for example, the task model for the task node 620 and a task model for the task node 622 are associated with each other via the material node 630, and the task model for the task node 620 and a task model for the task node 621 are associated with each other via the material node 650.

### <Result Instance>

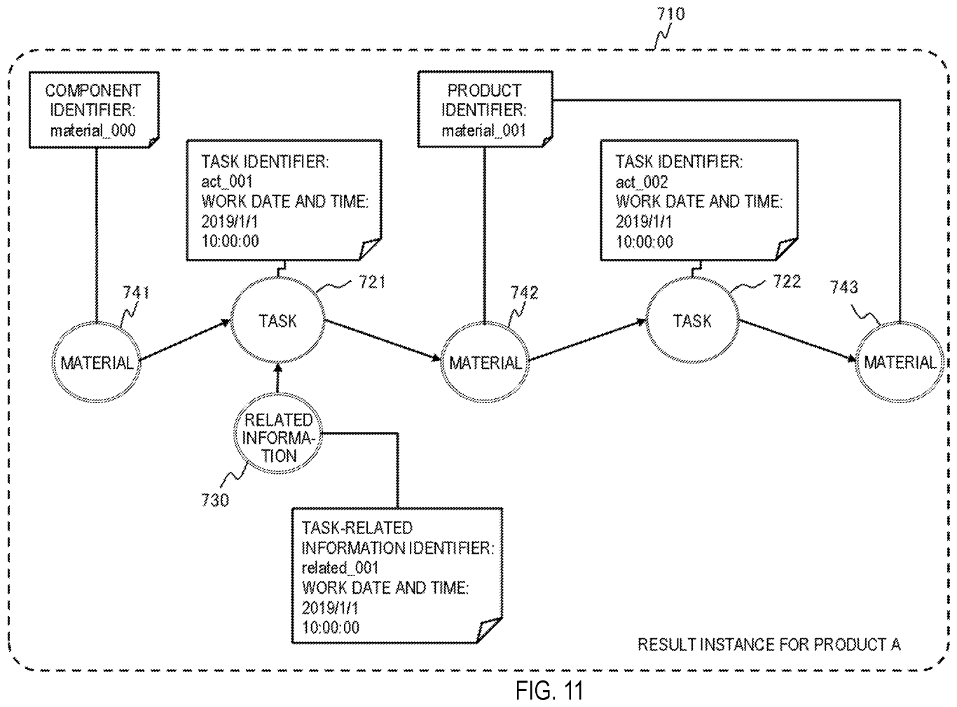

FIG. 11 is a diagram illustrating an example of a data structure of a result instance of one material for which tasks are executed. The result instance indicates, with the data structure, association of the material and the tasks actually executed for the material. This result instance may have a structure in which site data is stored at each node in a task model for each task executed for the product. The result instance may also have a structure storing key information for searching for the site data from the site data accumulation unit 141.

A result instance 710 illustrated in FIG. 11 is a result instance of a product A. The result instance 710 includes a task node 721 and a task node 722, and the task node 721 is associated with a task-related information node 730. The result instance 710 shows association that a product node 742 associated with the task node 721 is a component node associated with the task node 722. The task node 721 and the task node 722 are associated with each other via the material node 742.

The task node stores task identifier information uniquely indicating a task executed for the product A, information indicating a timing at which the task is executed, and the like. The task-related information node stores worker identifier information uniquely indicating a worker who executes the task, equipment identifier information uniquely indicating equipment used to execute the task, procedure identifier information uniquely indicating a procedure for executing the task, and the like.

A component node 741 associated with a component used in a first task executed for the product A stores component identifier information uniquely indicating a component used to generate the product A, and the like. Other material nodes store product identifier information uniquely indicating the product A, and the like.

The information collection system 170 can search for and acquire the task-related information associated with the product through the schema model and the result instance. Tasks assumed in advance at a design stage in the manufacture of the product are defined in the schema model. Information on a task that is actually executed but not defined in the schema model can be obtained from the result instance.

### <Creation of Schema Model>

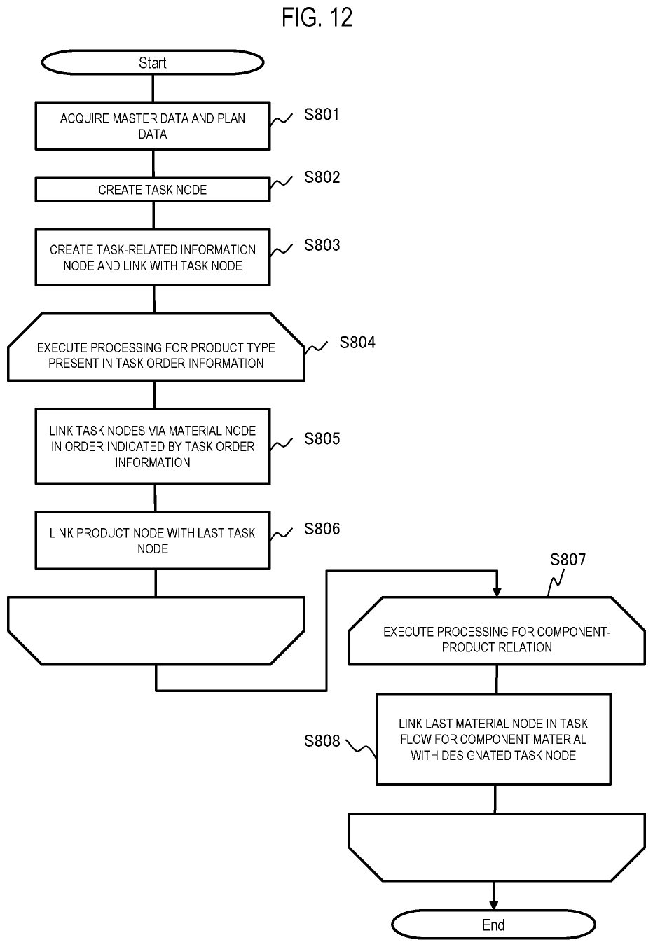

FIG. 12 is a diagram illustrating an example of a procedure for the process model creation system 110 to create the schema model. The procedure illustrated in FIG. 12 corresponds to an operation procedure of Sa302 to Sa306 executed by the process model creation system 110 and illustrated in FIG. 3.

The schema model creation unit 210 acquires the master data from the master data accumulation unit 142 and acquires the plan data from the plan data accumulation unit 143 (S801). Here, the plan data may be selected based on the product type designated by the user.

Next, regarding the task information 410 in the master data, the schema model creation unit 210 creates the task node associated with each task present in the task information 410 (S802).

Next, regarding the task-related information 420 in the master data, the schema model creation unit 210 creates the task-related information node associated with each piece of the task-related information present in the task-related information 420, and links the task node associated with the task indicated by the task identifier 411 in the task-related information 420 with the created task-related information node (S803).

Next, regarding the task order information 460 in the plan data, the schema model creation unit 210 executes processing for each product type indicated by the product type identifier 431 present in the task order information 460 (S804). The task nodes associated with respective tasks are linked via material nodes in an order indicated by the task order 462 in the task order information 460 (S805). A product node is linked with a last task node (S806). The association of the task nodes thus created is referred to as a schema flow for the product type.

Next, regarding the component-product relation information 470 in the plan data, the schema model creation unit 210 executes processing for each product type indicated by the product type identifier 431 present in the component-product relation information 470 (S807). A product node linked with a last task node in a schema flow for the product type indicated by the component type identifier 472 in the component-product relation information 470 is linked to the task node associated with the task indicated by the task identifier 411 (S808). The linkage of the task node, the task-related information node, and the material node thus created is referred to as the schema model.

### <Creation of Result Instance and Difference Data>

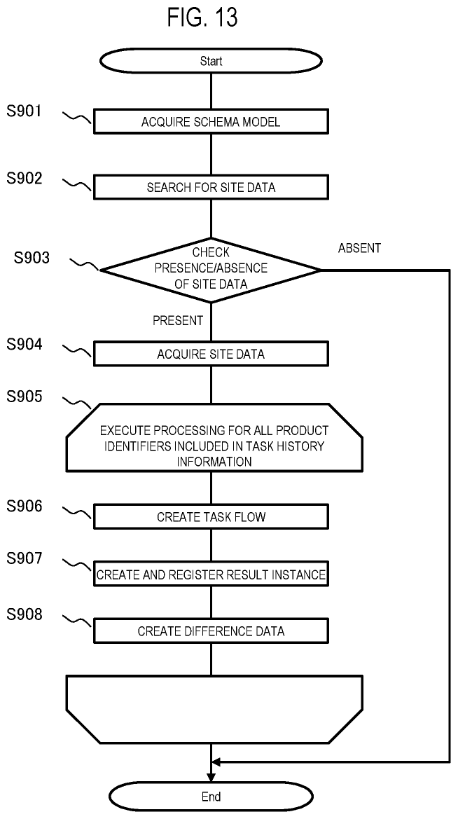

FIG. 13 is a diagram illustrating an example of a procedure for the process model creation system 110 to create the result instance and the difference data.

The procedure illustrated in FIG. 13 corresponds to an operation procedure of Sb302 to Sb306 executed by the process model creation system 110 and illustrated in FIG. 4.

The difference data creation unit 230 acquires the schema model from the association data model accumulation unit 150 (S901).

Next, the user searches for, via the operation terminal 180, the site data for which the result instance is to be created (S902). At this time, for example, the user selects or designates engine information or the like for which the result instance is to be created.

The result instance creation unit 220 acquires the site data stored in the site data accumulation unit 141 based on a condition input by the user via the operation terminal 180. When there is site data corresponding to the condition in the site data stored in the site data accumulation unit 141 (present in S903), the result instance creation unit 220 acquires the corresponding site data (S904). Meanwhile, when there is no site data corresponding to the condition (absent in S903), the result instance creation unit 220 ends the processing of creating the result instance.

Next, regarding the acquired site data, the result instance creation unit 220 executes the following series of processing for the site data for each product (S905). First, the result instance creation unit 220 creates a task flow indicating a flow of tasks executed for the product (S906). Subsequently, the result instance creation unit 220 creates the result instance for each product based on the created task flow (S907). Next, the difference data creation unit 230 extracts the differences between the schema model and the result instance, and creates the difference data, which is data indicating the extracted differences (S908).

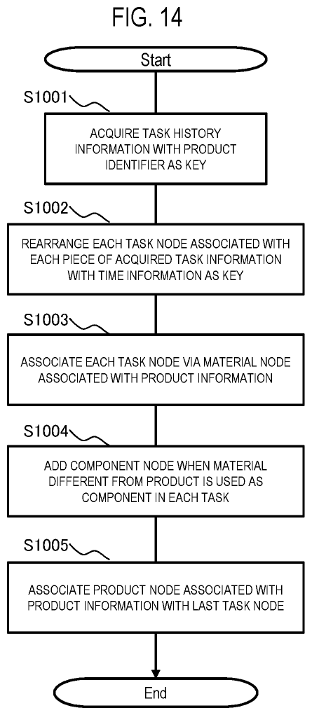

FIG. 14 is a diagram illustrating an example of a procedure for creating the task flow in step S906 of FIG. 13.

The result instance creation unit 220 first searches, with the product identifier 481 as a key, the task history information 480 for information that is related to the tasks executed for each product and included in the site data (S1001). Next, the result instance creation unit 220 rearranges the task node associated with each task in an order of time with the time information indicating an execution time of each task as a key (S1002), and further associates the task nodes with each other via the material nodes associated with the products (S1003).

When the task history information 480 includes, as the component identifier 483, information on a component material different from a product material corresponding to the product identifier 481, the result instance creation unit 220 links the task node and a material node associated with the component indicated by the information on the component material (S1004). Then, the task flow is created by associating a product node of the product with a task node of a task last executed for the product (S1005).

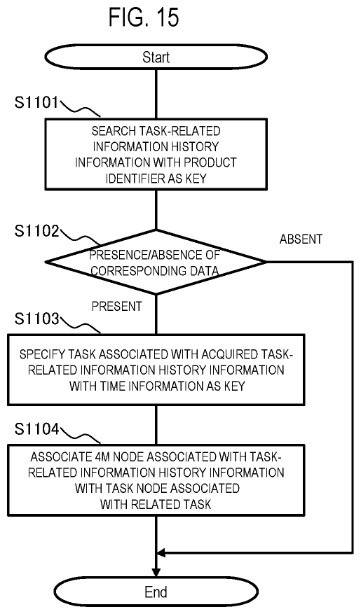

FIG. 15 is a diagram illustrating an example of a procedure for creating the result instance by associating, with the task flow, the information related to the tasks and the information on the components used to generate the product in step S907 of FIG. 13.

The result instance creation unit 220 searches the task-related information history information 490 with the product identifier 481 as a key to acquire the information that is related to the tasks executed for the product and included in the site data (S1101). When there is information corresponding to the search key (present in S1102), the result instance creation unit 220 identifies, based on the time information of the acquired task-related information history, the task node associated with the task associated with the task-related information history among the task nodes included in the task flow (S1103), and associates the task-related information node associated with the task-related information history with the task node (S1104). Meanwhile, when there is no information corresponding to the search key (absent in S1102), a series of processing for associating related information ends. Accordingly, the result instance is created for the product.

### <Creation of Difference Data>

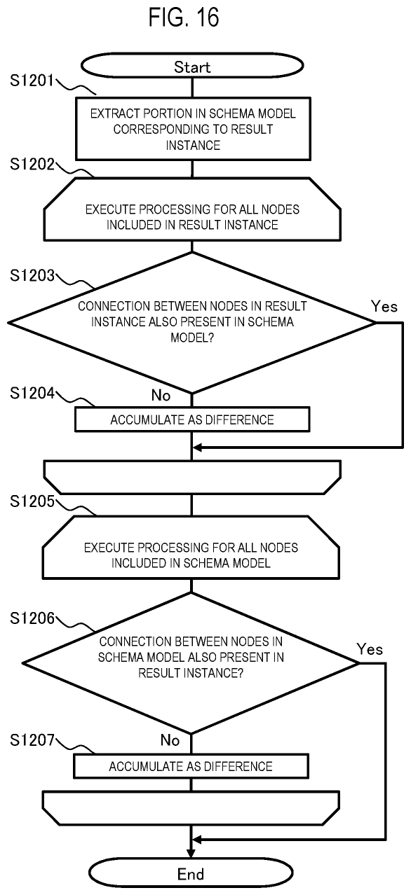

FIG. 16 is a diagram illustrating an example of a procedure for creating the difference data based on the result instance and the schema model in step S908 of FIG. 13.

The processing of creating the difference data is executed for all task nodes included in the data structure of the result instance and all task nodes included in the schema model (S1202, S1205).

The difference data creation unit 230 extracts a model corresponding to a product type of a product associated with the result instance from the schema model (S1201). The extracted model is referred to as a product type schema model.

Next, the difference data creation unit 230 checks, regarding association between the task node and the task-related information nodes and the material nodes in the result instance, whether the same association is present in the product type schema model (S1203). When, for all of the task nodes, the same association is present in the product type schema model (Yes in S1203), the difference data creation unit 230 determines that there is no difference between the result instance and the schema model with respect to the task node.

When, for any of the task nodes, the same association is not present in the product type schema model (No in S1203), the difference data creation unit 230 determines that there is a difference in the task node, and stores, as difference information into the difference data, the relation among the nodes in the result instance having the association that is not present in the product type schema model (S1204).

Next, the difference data creation unit 230 checks, regarding association between the task node, and the task-related information nodes, and the material nodes in the product type schema model, whether the same association is present in the data structure of the result instance (S1206). When, for all of the task nodes, association the same as the association with the task-related information nodes and the material nodes in the product type schema model is present in the data structure of the result instance (Yes in S1206), the difference data creation unit 230 determines that there is no difference with respect to the task node.

When, for any one of the task nodes, association the same as the association with the task-related information nodes and the material nodes in the product type schema model is not present in the data structure of the result instance (No in S1206), the difference data creation unit 230 determines that there is a difference in the task node, and stores, as difference information into the difference data, the relation among the nodes in the product type schema model having the association that is not present in the data structure of the result instance (S1207).

When accumulating the difference data in steps S1204 and S1207, the difference data creation unit 230 may store, as additional information of the differences into the difference data, information for specifying the result instance in which the difference is generated, and product type information on the product associated with the result instance. When two or more differences are generated simultaneously, the difference data creation unit 230 may store information for specifying the fact that the differences are generated simultaneously. The information on the difference between the nodes thus stored is the difference data.

### Specific Example of Result Instance and Difference Data

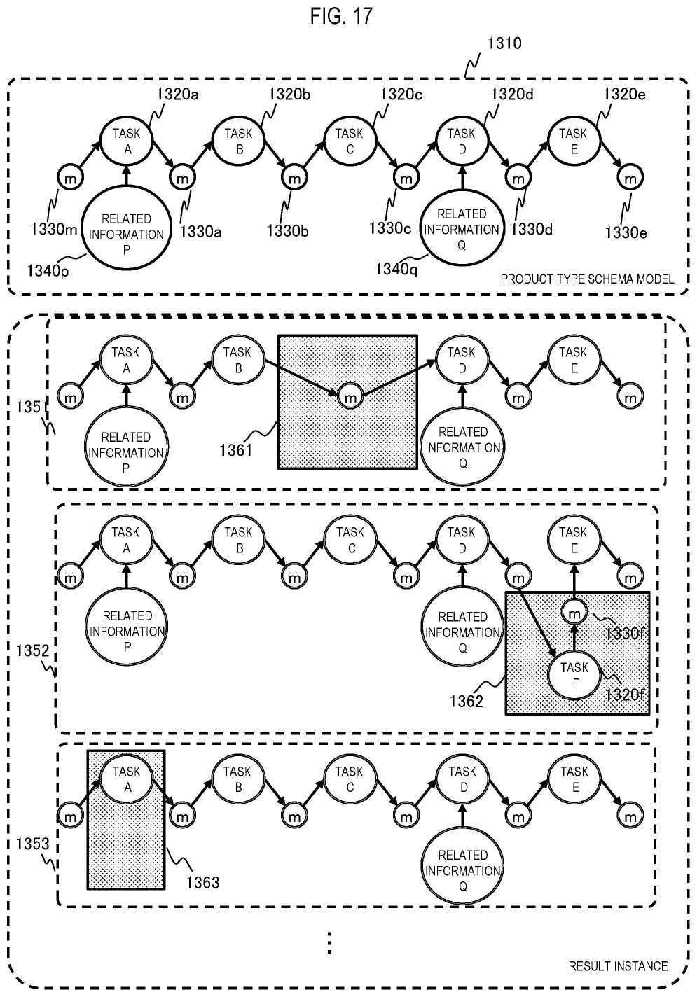

FIG. 17 is a diagram illustrating a specific example of extracting difference information between a product type schema model and result instances.

Specifically, in a product type schema model 1310, task nodes (1320a, 1320b, 1320c, 1320d, and 1320e), material nodes (1330m, 1330a, 1330b, 1330c, 1330d, and 1330e), and related information nodes (1340p and 1340q) are linked with each other. Meanwhile, as data structures of result instances, with respect to the schema model, there are a result instance 1351 in which the task node 1320c is not present, a result instance 1352 in which a task node 1320f is excessively present, and a result instance 1353 in which the task-related information node 1340p is not present. At this time, difference information 1361 indicating that the task node 1320c is not present in the result instance 1351, difference information 1362 indicating that the task node 1320f is excessively present in the result instance 1352, and difference information 1363 indicating that the task-related information node 1340p is not present in the result instance 1353 are stored in the difference data.

<Details and Degree of Similarity of Difference Data>

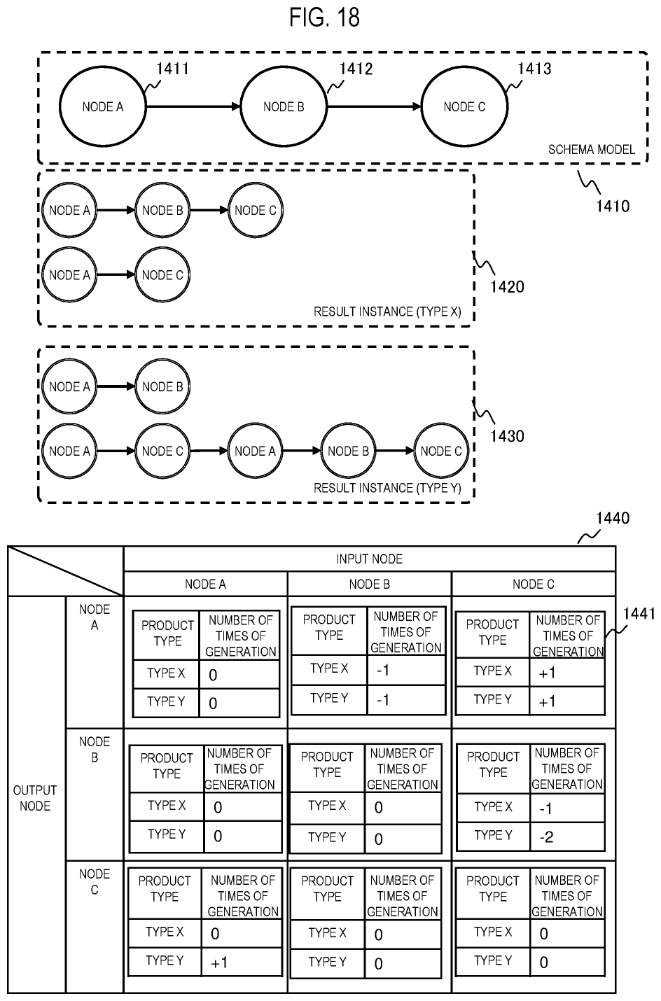

FIG. 18 is a diagram illustrating a specific example of the difference data obtained by accumulating the difference information.

Here, nodes illustrated in FIG. 18 are task nodes, material nodes, or task-related information nodes. Specifically, in a schema model 1410, a node A (1411), a node B (1412), and a node C (1413) are linked with each other. In a manufacturing process represented by the schema model, products of product types of a type X and a type Y are created, and product type schema models for both product types are equivalent to the schema model 1410.

Regarding the difference data, as illustrated in a difference data table 1440, difference information extracted from a result instance group 1420 of the product of the type X and difference information extracted from a result instance group 1430 of the product of the type Y may be organized and held in a manner of storing the number of times of generation for each product type between nodes in which the difference is generated. Specifically, when a linkage between the node A (1411) and the node C (1413) is not present in the schema model 1410, but a result instance in which the linkage between the nodes is present is generated in the result instance group 1420 of the type X, the number of times of generation of the difference may be stored for the type X between the nodes (1441).

The difference data may be stored by adding a degree of similarity between the stored difference information.

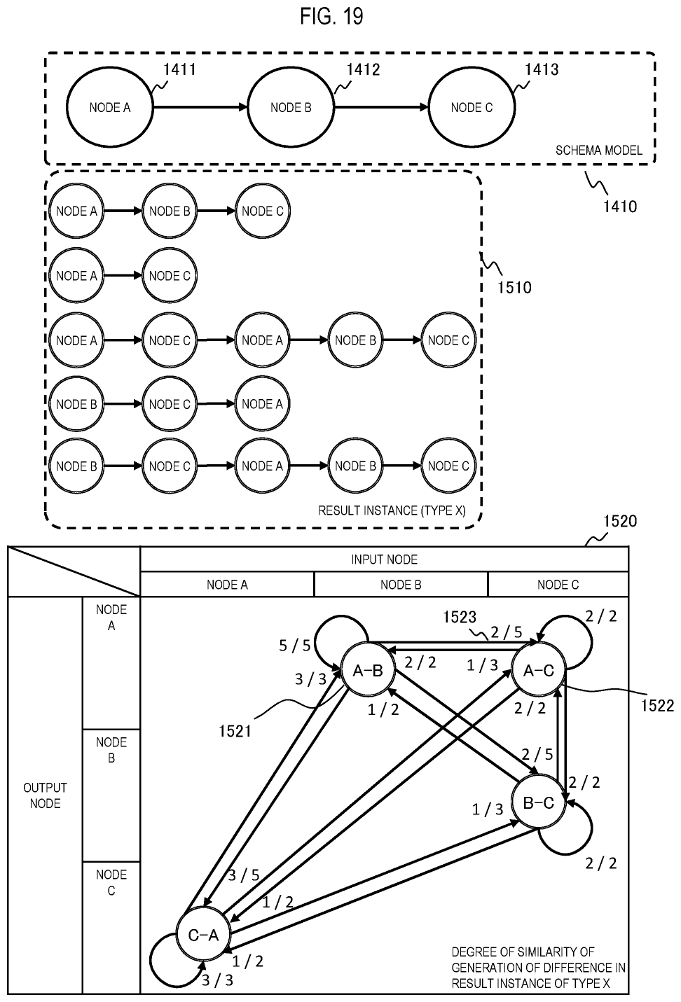

FIG. 19 is a diagram illustrating a specific example of the degree of similarity of the difference information stored in the difference data.

As illustrated in a degree of similarity diagram 1520, when one or more differences are generated in data structures of result instances in a result instance group 1510 of the type X with respect to the schema model 1410, with respect to a certain difference, the number of times or probability of generation of another difference including the certain difference may be stored as the degree of similarity. The degree of similarity indicates a possibility of simultaneous generation of the certain difference and the other difference.

In the degree of similarity diagram 1520, arrows and fractions displayed in the vicinity thereof indicate the number of times of generation of a difference at a tip end of the arrow with respect to the number of times of generation of a difference at the base end of the arrow. Specifically, when a difference (1521) is generated, the number of times or probability of generation of a difference (1522) within the same instance may be stored. The difference (1521) indicates that a linkage from the node A (1411) to the node B (1412) is present in the schema model 1410, but is not present in the result instance. The difference (1522) indicates that a linkage from the node A (1411) to the node C (1413) is not present in the schema model 1410, but is present in the result instance. The number of times or probability of generation are indicated by an arrow 1523 and a fraction in the vicinity thereof.

The degree of similarity between pieces of difference information may be stored with respect to pieces of difference information generated in each result instance of materials having a component-product relation. The number of times or probability of simultaneous generation of the materials having the component-product relation in each result instance may be set as the degree of similarity.

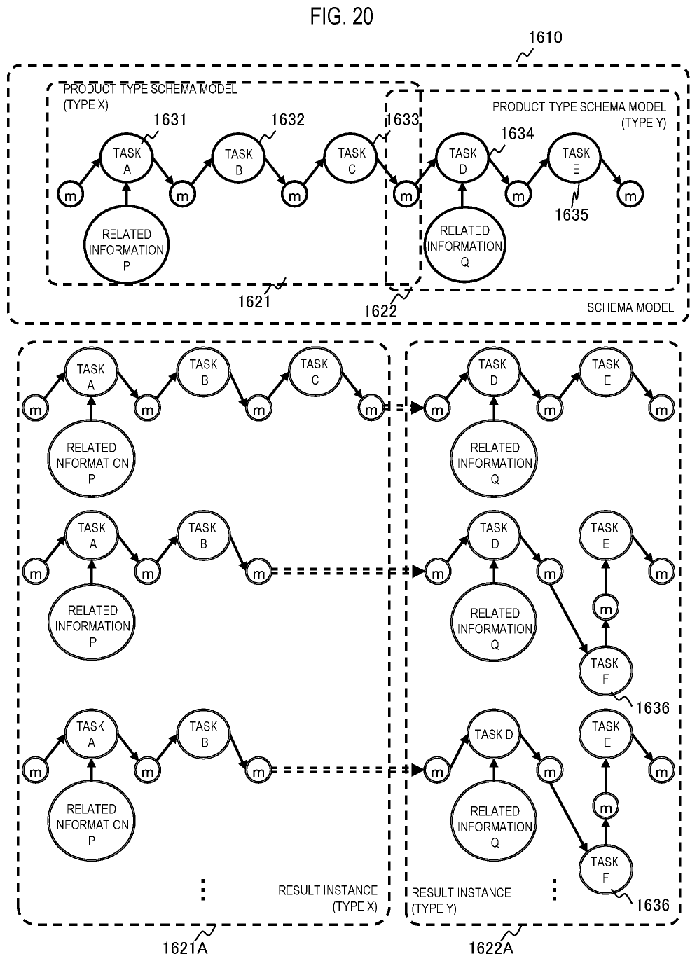

FIG. 20 is a diagram illustrating an example of a schema model and result instances when a type Y product is created using a type X product as a component.

A schema model 1610 includes a product type schema model 1621 for the type X and a product type schema model 1622 for the type Y. The product type schema model 1621 includes three task nodes (1631 to 1633). The product type schema model 1622 includes two task nodes (1634 and 1635). With respect to a result instance group 1621A of the type X and a result instance group 1622A of the type Y, for example, when differences indicating that a task node F (1636) is excessively present in the result instance of the type Y is generated simultaneously with a difference indicating that a task node C (1633) is not present in the result instance of the type X, a degree of similarity between these two pieces of difference information may be stored.

### <Creation of Modification Proposal>

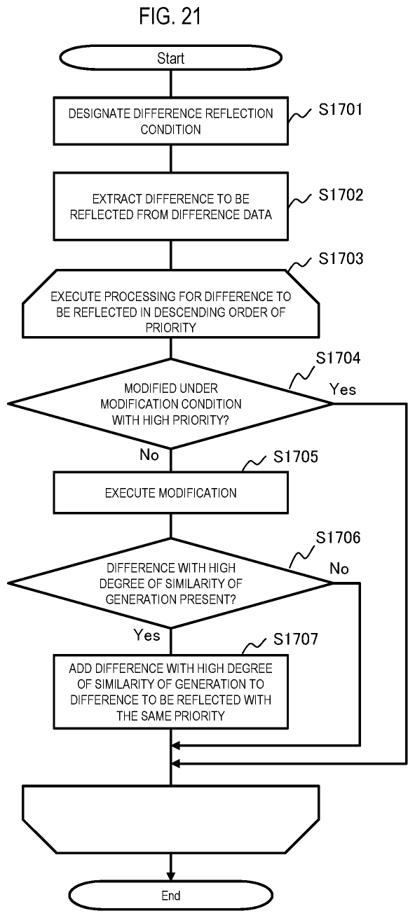

FIG. 21 is a diagram illustrating an example of a procedure for the process model creation system 110 to create the modification proposal for the schema model based on the schema model and the difference data.

The procedure illustrated in FIG. 21 corresponds to an operation procedure of steps Sc301 to Sc303 executed by the process model creation system 110 and illustrated in FIG. 5.

The user designates, via the operation terminal 180, a condition for selecting a difference to be reflected in the modification proposal of the schema model (S1701). As the condition for selecting the difference, a threshold value may be set for the number of times or probability of generation of the difference, and a difference exceeding the threshold value may be reflected in the modification proposal. A time period may be designated and a difference generated in a result instance related to a product for which an execution time period of a work related to the product is included in the time period designated by the user may be selected. A product type may be designated and a difference generated in a result instance related to a product matching the product type designated by the user may be selected. An option of a product may be designated as a condition and a difference generated in a result instance related to a product matching the option condition designated by the user may be selected. A plurality of conditions may be designated simultaneously. In this case, a priority may be set for each designated condition, and a difference matching any of the conditions may be reflected in the modification proposal, and when a plurality of different differences are generated at the same portion in the schema model, a difference with a higher priority may be reflected.

Next, the schema model modification unit 240 extracts difference information of the difference matching the designated condition in the difference data (S1702). The extracted difference information is referred to as difference information to be reflected. The schema model modification unit 240 executes the following series of processing for each difference included in the difference information to be reflected (S1703).

First, with respect to the difference information, when a modification based on another piece of difference information is executed for the portion where the difference is generated in the schema model (Yes in S1704), the schema model modification unit 240 does not execute a modification, and ends the processing with respect to the difference information. When the modification based on the other piece of difference information is not executed for the portion where the difference is generated (No in S1704), the schema model modification unit 240 reflects the difference in the schema model (S1705). Accordingly, when differences extracted under a plurality of conditions are generated at the same portion and are contradictory to each other, a difference matching a condition with a higher priority may be preferentially reflected in the modification proposal of the schema model.

At this time, a difference of which a degree of similarity with the difference reflected in the modification proposal exceeds a threshold value may be added to the difference information to be reflected (S1706 and S1707). Accordingly, a difference having a high degree of similarity with the difference reflected in the modification proposal may also be reflected in the modification proposal. The threshold value of the degree of similarity may be set by the user when designating the condition for reflecting the difference.

### <Addition of Characteristic>

When creating the modification proposal of the schema model, the schema model modification unit 240 may add, based on differences in configuration between the schema model before being modified and the modification proposal, to a task node added in the modification proposal, information indicating a characteristic of a task corresponding to the task node.

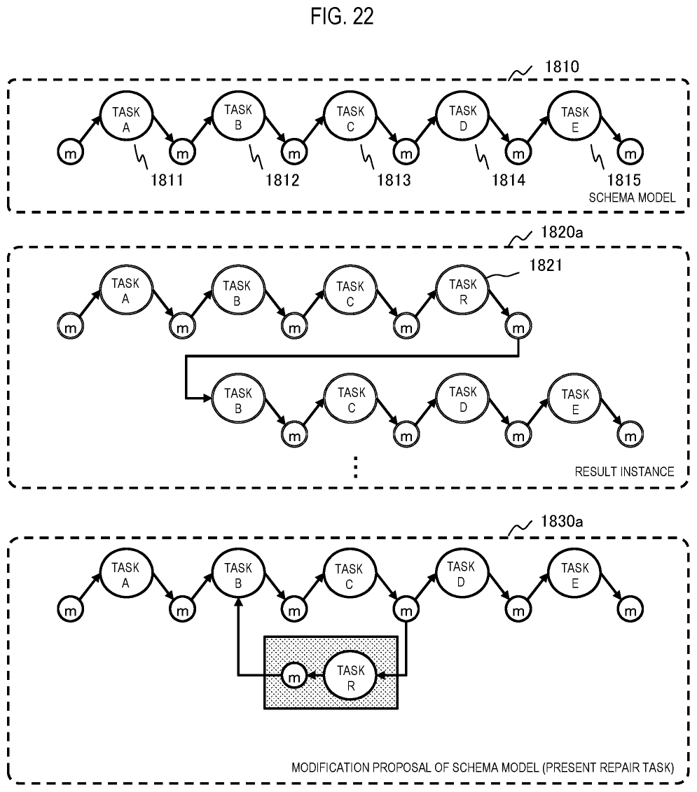

FIG. 22 is a diagram illustrating an example in which the schema model modification unit 240 adds, to the task node added in the modification proposal, a characteristic indicating that the added task node is a task node associated with a repair task. The repair task is a task of improving quality of a product created in a downstream task and returning the product to an upstream task. For example, when a defect occurs in a product, work for eliminating the defect corresponds to the repair task.

A schema model 1810 includes five task nodes 1811 to 1815. A difference between a result instance group 1820a and the schema model 1810 is that the result instance group 1820a includes a task node 1821 that is not defined in the schema model 1810. The task node 1821 is connected downstream of the task node 1813 and is connected to the task node 1812 passed from the task node 1821. In a case of such a structure, the schema model modification unit 240 may create a modification proposal 1830a of the schema model in which a task node corresponding to the task node 1821 and a material node corresponding to a product thereof are added to a position branching from a material node corresponding to a product of the task node 1813 of the schema model 1810, and the added material node is connected to the task node 1812, and the schema model modification unit 240 may add, to the added task node, a characteristic indicating that the added task node is a task node associated with a repair task on the site.

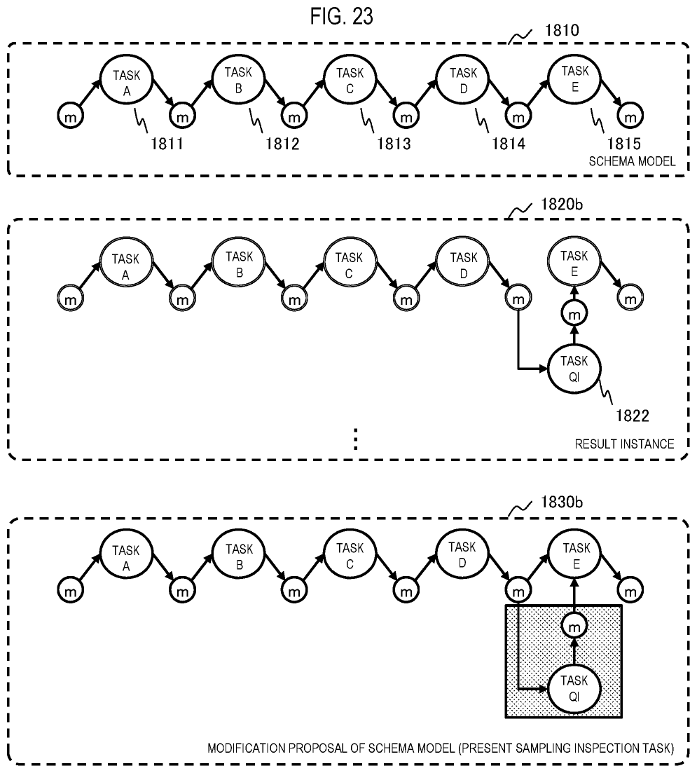

FIG. 23 is a diagram illustrating an example in which the schema model modification unit 240 adds, to the task node added in the modification proposal, a characteristic indicating that the added task node is a task node associated with a sampling inspection task. The sampling inspection task is a task of inspecting a part of products of a certain task as samples.

A difference between a result instance group 1820b and the schema model 1810 is that the result instance group 1820b includes a task node 1822 that is not defined in the schema model 1810. The task node 1822 is connected to a material node corresponding to a product of the task node 1814 present in the schema model 1810, and a material node corresponding to a product of the task node 1822 is connected to the task node 1815 present in the schema model 1810. In a case of such a structure, the schema model modification unit 240 may create a modification proposal 1830b of the schema model in which a task node corresponding to the task node 1822 and a material node corresponding to a product thereof are added to a position branching from the material node corresponding to the product of the task node 1814 of the schema model 1810, and the added material node is connected to the task node 1815, and the schema model modification unit 240 may add, to the added task node, a characteristic indicating that the added task node is a task node associated with a sampling inspection task on the site.

### <Screen Display>

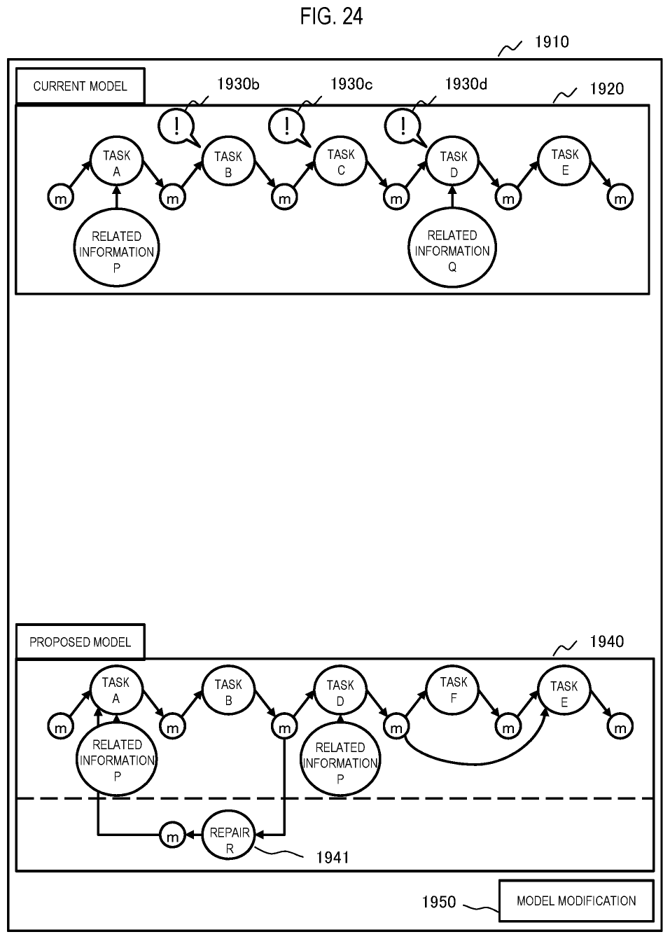

FIG. 24 is a diagram illustrating an example of a screen that presents the modification proposal of the schema model to the user.

A screen of a user interface 1910 illustrated in FIG. 24 includes a region 1920 for displaying a current schema model, a region 1930 for displaying a node in which data structure differences are generated with respect to the current schema model, a region 1940 for displaying a proposed modification proposal of the schema model, a region 1950 of a button for instructing application of the proposed modification proposal of the schema model as a schema model, and the like.

In the region 1920 for displaying the current schema model, a schema model registered in the association data model accumulation unit 150 is displayed.

In the region 1930 for displaying the node in which the data structure differences are generated, one or more nodes in which difference from the schema model are generated in the modification proposal of the schema model created by the schema model modification unit 240 are displayed in a recognizable manner.

In the region 1940 for displaying the modification proposal of the schema model, the modification proposal created by the schema model modification unit 240 is displayed. When there is a task node 1941 to which a characteristic is added by the schema model modification unit 240 in the modification proposal, the task node may be displayed to be distinguishable from other task nodes.

In the user interface 1910, when presenting the modification proposal of the schema model to the user, details of the differences in the data structures of the current schema model and the modification proposal may be displayed together.

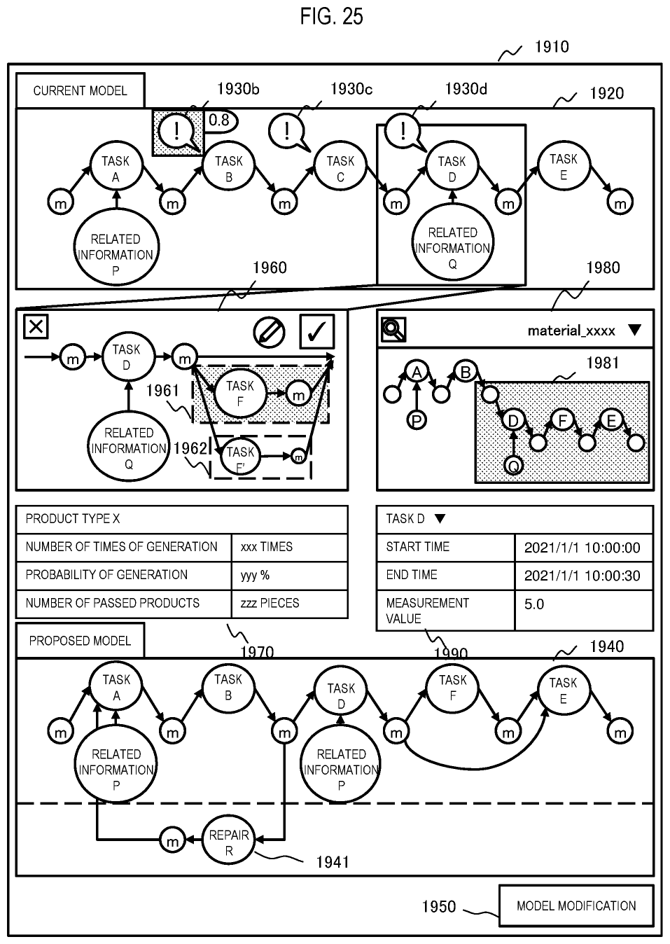

FIG. 25 is a diagram illustrating an example of displaying differences in the data structure modified in the modification proposal of the schema model. When the user selects a region 1930d for displaying the node in which the data structure difference is generated, the user interface 1910 displays a difference in the data structure modified in the modification proposal of the schema model with respect to the node.

In the example of FIG. 25, the user interface 1910 displays details of the difference generated at the node displayed in the region 1930d in a region 1960 for displaying details of a difference. The data structure of the modification proposal may be displayed as the details of the difference. When a plurality of different differences in the data structure are generated in the node displayed in the region 1930d, and any one of the differences is adopted in the modification proposal, a data structure (1961) of the modification proposal of the schema model and a data structure (1962) of the difference not adopted in the modification proposal may be displayed in the region 1960. In the region 1960, the user can change the difference reflected in a certain node in the modification proposal from the data structure displayed in the region 1961 to the data structure displayed in the region 1962, can manually change the connection between the nodes, or can select not to reflect the difference in the node.

The user interface 1910 may further include a region 1970 for displaying a characteristic of a product, in which the difference is generated, at the time of displaying the details of the difference in the region 1960. In the region 1970, the number of times and probability of generation, and the like may be displayed for each of one or more product types for the product in which the difference is generated.

The user interface 1910 may further include a region 1980 for displaying a result instance of one or more products, in which the difference is generated, at the time of displaying the details of the difference in the region 1960. The region 1980 displays a result instance 1981 related to the product in which the difference is generated, and when a result instance related to a component used for the product or a result instance related to a product in which the product is used as a component is present, the region 1980 may link these result instances with the result instance 1981 and display the result instances.

Further, the user interface 1910 may further include a region 1990 for displaying, at the time of displaying the result instance of the product in which the difference is generated and the result instance of the component of the product or an upper product using the product as a component in the region 1980, information stored in each node in the result instances.

When displaying the details of the difference generated in the node displayed in the region 1930d in the region 1960 for displaying the details of the difference, the user interface 1910 may display that a degree of similarity is high in a region 1930b that displays a node in which a difference of which a degree of similarity with the difference generated in the node displayed in the region 1930d exceeds the threshold value. At this time, an index indicating the degree of similarity may be set as a probability of simultaneous generation, and a value thereof may be displayed.

In a case where the fact that the degree of similarity is high in the region 1930b is displayed, when the user selects the region 1930b, the user interface 1910 may display detailed information related to the similarity between mutually similar differences.

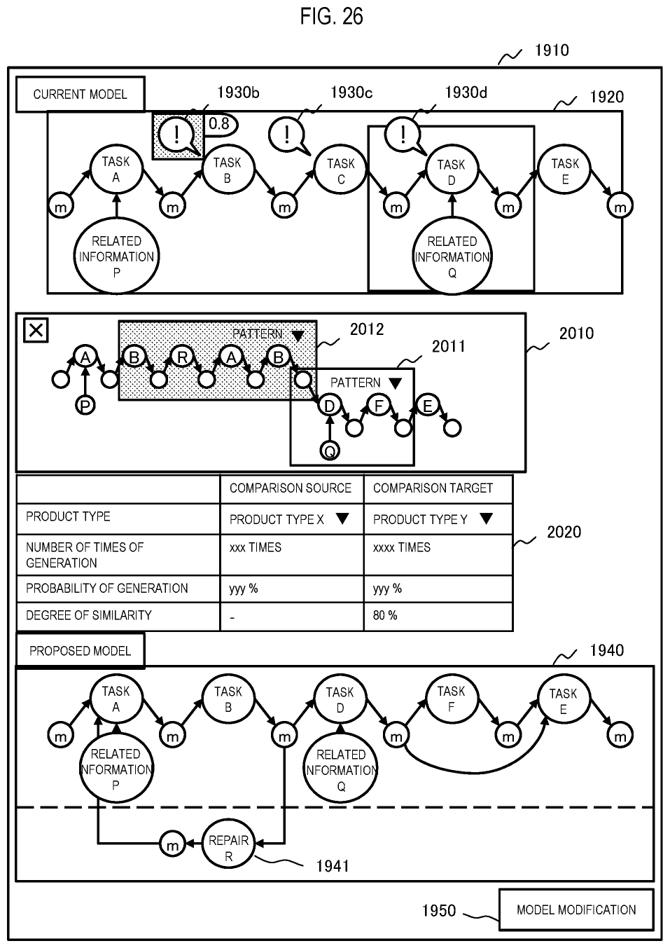

FIG. 26 is a diagram illustrating an example of an interface that displays the detailed information related to the similarity of mutually similar differences.

In the example of FIG. 26, it is assumed that a degree of similarity between the difference generated in the node displayed in the region 1930d and the difference generated in the node displayed in the region 1930b exceeds the threshold value. It is assumed that the region 1930d represents a comparison source, and the region 1930b represents a comparison destination.

The user interface 1910 displays detailed information on the similarity between a difference 2011 generated in the node displayed in the region 1930d and a difference 2012 generated in the node displayed in the region 1930b.

A data structure including a series of one or more result instances and including the difference 2011 and the difference 2012 is displayed in a region 2010. Here, for the difference 2011, when there is a difference that is not adopted in the modification proposal of the schema model in addition to a difference that is adopted in the modification proposal, the display may be switched from a data structure of the difference that is adopted in the modification proposal to a data structure of the difference that is not adopted in the modification proposal.

When there is a difference that is not adopted in the modification proposal in addition to a difference that is adopted in the modification proposal at the portion of the difference 2012, the display of the difference 2012 may be switched to a data structure of the difference that is not adopted in the modification proposal.

When the details of the mutually similar differences are displayed in the region 2010, there may be a region 2020 for displaying characteristics of products in which the differences are generated for the difference 2011 which is the comparison source of the degree of similarity and the difference 2012 which is the comparison destination respectively. In the region 2020, the number of times and probability of generation, and the like may be displayed for each of one or more product types with respect to the products in which the differences are generated. The region 2020 may include information indicating a degree of similarity between the difference 2011 which is the comparison source of the degree of similarity and the difference 2012 which is the comparison destination. The information indicating the degree of similarity may be, for example, a value of the probability of simultaneous generation.

As described above, according to the embodiment described above, the process model creation system 110 can extract the differences between the process model, which indicates the association of the tasks constituting the manufacturing process and the site data, and the data structure which indicates the association of the data in the site data generated at the manufacturing site, and can create, by using the degree of similarity of the differences, a process model in which the differences having high association are reflected. As a result, failing to reflect differences in a causal relation in the process model can be prevented, and the process model can be modified in accordance with the site data. Therefore, an effect of more accurately collecting and analyzing the site data can be expected.

The process model creation system 110 can present, for the task node added in the modified process model, the characteristic of the task associated with the task node, and thus an effect of facilitating understanding of the user on the process model can be expected.

In the embodiment described above, an example is described in which a manufacturing process model is created based on the site data generated in the manufacturing process at the manufacturing site, but the process model creation system 110 can be applied to any type of business that includes a plurality of tasks and generates site data, without being limited to the manufacturing site. For example, in the logistics industry or transportation industry, there are a plurality of processes constituting a transportation process from arrival of cargo to sorting, storage, packing, and delivery, and a transportation process model can be created based on site data related to the transportation process in the same way as the process model at the manufacturing site.

The invention is not limited to the embodiment described above, and includes various modifications. For example, the embodiment described above is described in detail for facilitating understanding the invention, and is not necessarily limited to those including all the configurations described above. The configuration of one embodiment may be partially or entirely replaced with a configuration of another embodiment, and the configuration of the other embodiment may be added to the configuration of the one embodiment. The configuration of each embodiment may be partially or entirely added to, deleted from, and/or replaced with another configuration. The above configurations, functions, processing units, and the like may be partially or entirely implemented by hardware such as through design using an integrated circuit.

The embodiment described above includes the following matters. However, the matters included in the present embodiment are not limited to the following.

### (Matter 1)

A process model creation system for creating a model used for managing, in a process including a plurality of tasks, site data acquired on a site of each task, and defining a flow of the tasks in the process, the process model creation system including:
a model accumulation unit configured to accumulate the model;
a difference data creation unit configured to create, based on the site data acquired on the site, an instance indicating a flow of actually executed tasks, and extract differences between the instance and the model as difference data; and a model modification unit configured to create a modification proposal of the model based on the difference data.

Accordingly, the differences between the flow of the tasks indicated by the instance created based on the data actually acquired on the site and the flow of the tasks indicated by the model created in advance are extracted, and the modification proposal of the model is created based on the differences, and thus a process model suitable for the tasks generated on the site can be created.

### (Matter 2)

The process model creation system according to Matter 1, in which
the difference data creation unit further calculates the number of times or frequency of generation of each of the differences, and a degree of similarity between the differences indicating a possibility that a certain difference and another difference are generated in the same instance, and
when the number of times or frequency of generation of a first difference exceeds a first threshold value and a degree of similarity between the first difference and a second difference exceeds a second threshold value, the model modification unit creates a modification proposal in which both the first difference and the second difference are adopted.

Accordingly, differences having a high simultaneous generation frequency are both adopted in the modification proposal, a modification proposal that enables well-proportioned modifications can be created.

### (Matter 3)

The process model creation system according to Matter 2, in which
when a product created by a task in a first instance is used as a component in a task in a second instance, the difference data creation unit further calculates a degree of similarity indicating a possibility of simultaneous generation of a difference generated in the first instance and a difference generated in the second instance, and
when the difference in the first instance exceeds the first threshold value, and the degree of similarity between the difference in the first instance and the difference in the second instance exceeds the second threshold value, the model modification unit creates a modification proposal in which both the difference in the first instance and the difference in the second instance are adopted.

Accordingly, when a product of a certain task has a relation of being a component of another task, differences having a high simultaneous generation frequency are both adopted in the modification proposal, and a modification proposal that enables well-proportioned modifications can be created.

### (Matter 4)

The process model creation system according to Matter 1, in which
a designation of a condition for narrowing down a difference to be extracted from an instance or an instance from which a difference is to be extracted, is received from a user, and
the model modification unit specifies, from the difference data, a difference extracted from an instance matching the designated condition, or a difference matching the designated condition, and creates a modification proposal of the model based on the specified difference.

Accordingly, a modification proposal in which a difference matching the condition designated by the user is adopted can be created.

### (Matter 5)

The process model creation system according to Matter 4, in which
a plurality of conditions each of which is used for extracting a difference when at least one of the conditions is matched, and each of which is given a priority, are received, and
when a difference matching any one of the conditions and a difference matching another condition contradict each other, the model modification unit preferentially adopts, in the modification proposal, a difference matching a condition having a higher priority.

Accordingly, a plurality of conditions can be set, and in a case in which the plurality of conditions contradict each other, a difference having a higher priority is applied, and thus a modification proposal in which a user's intention is appropriately applied can be created.

### (Matter 6)

The process model creation system according to Matter 1, in which
the model modification unit specifies, based on a difference in data configuration between the model and the modification proposal, a characteristic of a task to be added to the model in the modification proposal.

Accordingly, the characteristic of the task to be added to the model in the modification proposal is specified based on the difference in the data configuration between the current model and the modification proposal, and thus the characteristic of the task to be added can be easily specified.

### (Matter 7)

The process model creation system according to Matter 6, in which
when the modification proposal has a configuration in which the flow of the tasks is returned from a task present in the model before being modified to a task present upstream of the task via a task added in the modification proposal, the model modification unit specifies a characteristic that the added task is a repair task of improving a product created in a downstream task and returning the product to an upstream task.

Accordingly, the characteristic of the repair task can be easily specified.

### (Matter 8)

The process model creation system according to Matter 6, in which
when the modification proposal has a configuration in which a first task present in the model before being modified is connected to a task added in the modification proposal, and the added task is connected to a second task present in a stage next to that of the first task present in the model, and an instance including the added task is generated repeatedly at a predetermined time interval, the model modification unit specifies a characteristic that the added task is a sampling inspection task of inspecting a part of products of a certain task as a sample.

Accordingly, the characteristic of the sampling inspection task can be easily specified.

### (Matter 9)

The process model creation system according to Matter 6, in which
the model modification unit displays a structure of the modification proposal on a screen by nodes corresponding to the tasks, products, or components, and arrows connecting the nodes along the flow of the tasks.

Accordingly, the modification proposal can be easily visually understood through the nodes and the arrows.

### (Matter 10)

The process model creation system according to Matter 9, in which
the model modification unit displays a node and/or an arrow of a portion modified in the modification proposal in a recognizable manner in the display of the structure of the modification proposal.

Accordingly, modified portions in the modification proposal can be easily visually recognized.

### (Matter 11)

The process model creation system according to Matter 9, in which
the model modification unit displays a node of a task to which a characteristic is specified in the modification proposal in a visually recognizable manner in the display of the structure of the modification proposal.

Accordingly, the task that is added to the modification proposal and is characterized can be easily visually recognized.

### (Matter 12)

The process model creation system according to Matter 9, in which
the difference data creation unit further calculates the number of times or frequency of generation of each of the differences, and a degree of similarity between the differences indicating a possibility that a certain difference and another difference are generated in the same instance, and
when the number of times or frequency of generation of a first difference exceeds a first threshold value and a degree of similarity between the first difference and a second difference exceeds a second threshold value, the model modification unit creates a modification proposal incorporating the first difference and the second difference, and when a selection operation is executed for a portion corresponding to the first difference in the display of the structure of the modification proposal, the model modification unit displays a portion corresponding to the second difference in a recognizable manner.

Accordingly, differences with a high degree of similarity can be easily understood.

### REFERENCE SIGNS LIST

110 process model creation system
120 network
130 data generation device
141 site data accumulation unit
142 master data accumulation unit
143 plan data accumulation unit
150 association data model accumulation unit
160 association data accumulation unit
170 information collection system
180 operation terminal
210 schema model creation unit
220 result instance creation unit
230 difference data creation unit
240 schema model modification unit

1. A process model creation system for creating a model used for managing, in a process including a plurality of tasks, site data acquired on a site of each task, and defining a flow of the tasks in the process, the process model creation system comprising:
a model accumulation unit configured to accumulate the model;
a difference data creation unit configured to create, based on the site data acquired on the site, an instance indicating a flow of actually executed tasks, and extract differences between the instance and the model as difference data; and
a model modification unit configured to create a modification proposal of the model based on the difference data.

2. The process model creation system according to claim 1, wherein
the difference data creation unit further calculates the number of times or frequency of generation of each of the differences, and a degree of similarity between the differences indicating a possibility that a certain difference and another difference are generated in the same instance, and
when the number of times or frequency of generation of a first difference exceeds a first threshold value and a degree of similarity between the first difference and a second difference exceeds a second threshold value, the model modification unit creates a modification proposal in which both the first difference and the second difference are adopted.

3. The process model creation system according to claim 2, wherein
when a product created by a task in a first instance is used as a component in a task in a second instance, the difference data creation unit further calculates a degree of similarity indicating a possibility of simultaneous generation of a difference generated in the first instance and a difference generated in the second instance, and
when the difference in the first instance exceeds the first threshold value, and the degree of similarity between the difference in the first instance and the difference in the second instance exceeds the second threshold value, the model modification unit creates a modification proposal in which both the difference in the first instance and the difference in the second instance are adopted.

4. The process model creation system according to claim 1, wherein
a designation of a condition for narrowing down a difference to be extracted from an instance or an instance from which a difference is to be extracted, is received from a user, and
the model modification unit specifies, from the difference data, a difference extracted from an instance matching the designated condition, or a difference matching the designated condition, and creates a modification proposal of the model based on the specified difference.

5. The process model creation system according to claim 4, wherein
a plurality of conditions each of which is used for extracting a difference when at least one of the conditions is matched, and each of which is given a priority, are received, and
when a difference matching any one of the conditions and a difference matching another condition contradict each other, the model modification unit preferentially adopts, in the modification proposal, a difference matching a condition having a higher priority.

6. The process model creation system according to claim 1, wherein
the model modification unit specifies, based on a difference in data configuration between the model and the modification proposal, a characteristic of a task to be added to the model in the modification proposal.

7. The process model creation system according to claim 6, wherein
when the modification proposal has a configuration in which the flow of the tasks is returned from a task present in the model before being modified to a task present upstream of the task via a task added in the modification proposal, the model modification unit specifies a characteristic that the added task is a repair task of improving a product created in a downstream task and returning the product to an upstream task.

8. The process model creation system according to claim 6, wherein
when the modification proposal has a configuration in which a first task present in the model before being modified is connected to a task added in the modification proposal, and the added task is connected to a second task present in a stage next to that of the first task present in the model, and an instance including the added task is generated repeatedly at a predetermined time interval, the model modification unit specifies a characteristic that the added task is a sampling inspection task of inspecting a part of products of a certain task as a sample.

9. The process model creation system according to claim 6, wherein
the model modification unit displays a structure of the modification proposal on a screen by nodes corresponding to the tasks, products, or components, and arrows connecting the nodes along the flow of the tasks.

10. The process model creation system according to claim 9, wherein
the model modification unit displays a node and/or an arrow of a portion modified in the modification proposal in a recognizable manner in the display of the structure of the modification proposal.

11. The process model creation system according to claim 9, wherein
the model modification unit displays a node of a task to which a characteristic is specified in the modification proposal in a visually recognizable manner in the display of the structure of the modification proposal.

12. The process model creation system according to claim 9, wherein
the difference data creation unit further calculates the number of times or frequency of generation of each of the differences, and a degree of similarity between the differences indicating a possibility that a certain difference and another difference are generated in the same instance, and
when the number of times or frequency of generation of a first difference exceeds a first threshold value and a degree of similarity between the first difference and a second difference exceeds a second threshold value, the model modification unit creates a modification proposal incorporating the first difference and the second difference, and when a selection operation is executed for a portion corresponding to the first difference in the display of the structure of the modification proposal, the model modification unit displays a portion corresponding to the second difference in a recognizable manner.

13. A process model creation method for creating a model used for managing, in a process including a plurality of tasks, site data acquired on a site of each task, and defining a flow of the tasks in the process, the process model creation method comprising:
a computer executing processing of:
accumulating the model;
creating, based on the site data acquired on the site, an instance indicating a flow of actually executed tasks, and extracting differences between the instance and the model as difference data; and
creating a modification proposal of the model based on the difference data.
